(19) United States
(12) Patent Application Publication
(10) Pub. No.: US 2020/0226489 A1
(43) Pub. Date: Jul. 16, 2020

(54) FACILITATING ONLINE RESOURCE ACCESS WITH BIAS CORRECTED TRAINING DATA GENERATED FOR FAIRNESS-AWARE PREDICTIVE MODELS

(71) Applicant: Adobe Inc., San Jose, CA (US)

(72) Inventors: Yancheng Li, Stanford, CA (US); Moumita Sinha, Cupertino, CA (US); Haichun Chen, Sunnyvale, CA (US)

(21) Appl. No.: 16/247,297

(22) Filed: Jan. 14, 2019

(51) Int. Cl. G06N 20/00; G06N 5/02

(52) U.S. Cl. CPC G06N 20/00; G06N 5/02

(57) ABSTRACT

In some embodiments, a computing system generates de-biased training data for fairness-aware predictive models to facilitate online resource access. The computing system extracts latent features from training data of a first machine learning model for predicting an access flag for a user indicating the ability of the user to access an online environment. Based on the latent features, the computing system trains a second machine learning model to generate de-biased training data by applying a loss function that includes loss terms associated with an individual bias and a group bias of the training data. The de-biased training data are utilized to train the first machine learning model and to update the access flag for the user by applying the first machine learning model to attributes of the user. A user device associated with the user can be provided with access to the online environment according to the updated access flag.

### TECHNICAL FIELD

This disclosure relates generally to facilitating online resource access by building fairness-aware predictive models. More specifically, but not by way of limitation, this disclosure relates to generating bias-corrected training data for training fairness-aware predictive models, and, in some cases, facilitating online resource access using predictive models trained using the bias corrected training data.

### BACKGROUND

The Internet provides user devices with access to different online resources via interactive computing environments. For example, user devices can utilize online storage resources for storing digital data online, can utilize cloud computing resources to perform various computing tasks, or can access content online by requesting and receiving content from a content provider. Online resources providers, however, may have limited capacity to service requests from end user devices over a data network. An excess number of requests from end user devices can degrade the quality of service for the online resources providers by, for example, decreasing the bandwidth or processing resources that may be allocated to any given user device.

In one example, these resource-allocation issues can be addressed by employing one or more predictive models that limit the number of users that are provided access to online resources based on attributes associated with the user. Training the predictive models involves adjusting model parameters based on training data observed from past decisions on providing users with access to online resources. As a result, inherent bias from past decisions are propagated to the predictive models through the training data, resulting in biased prediction for future decisions. For example, bias might have been introduced into the past decisions by including a bias attribute, such as whether a user is a loyalty member of the resource provider. Considering such an attribute when making decision would introduce bias because granting the user's current access to the resources should be based on the user's use activities of the resources, and whether a user is a loyalty member is irrelevant. Training data collected based on such biased decisions would lead to a biased predictive model that has the tendency to provide access for loyalty members while denying access for non-loyalty members.

Bias can include group bias and individual bias. Group bias occurs when proportion of individuals in a selected group with a positive outcome is not identical to the population proportion as a whole. Individual bias occurs when individuals who have similar attributes do not have similar outcomes. Generating de-biased training data can help to build fairness aware predictive models, thereby achieving fair decisions in providing users with resource access. Existing bias correction methods, however, are insufficient for the task because they only focus on reducing group bias of the training data without considering the individual bias sufficiently. Prior methods have either tried to reduce group bias only or a combination of group and individual bias, with most reduction in group bias. As a result, these bias correction methods fail to eliminate biased training data, and thus produced biased predictive models that may be ineffective for effectively allocating access to electronic resources.

### SUMMARY

Certain embodiments involve generating de-biased training data for fairness-aware predictive models, and, in some cases, facilitating online resource access by users using the fairness-aware predictive models. In one example, a de-biasing server can extract latent features from training data of a first machine learning model for predicting an access flag for a user. The access flag is associated with an ability of the user to access an online environment. Based on the latent features, the de-biasing server can train a second machine learning model to generate de-biased training data for the first machine learning model. Training the second machine learning model can include applying a loss function that includes a loss term associated with an individual bias of the de-biased training data and another loss term associated with a group bias of the de-biased training data. The de-biased training data are then utilized to train the first machine learning model and to update an access flag for a user by applying the first machine learning model to attributes associated with the user. Based on the updated access flag for the user, a user device associated with the user can be provided with access to the online environment.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which an access-facilitation computing system employs a de-biasing server to generate de-biased training data for access predictive models and facilitate online resource access, according to certain embodiments of the present disclosure.

FIG. 2 depicts an example of a process for facilitating the online resource access based on an access predictive model trained using de-biased training data, according to certain embodiments of the present disclosure.

FIG. 3 depicts an example of a process for training a de-biasing model used by the process of FIG. 2, according to certain embodiments of the present disclosure.

FIG. 4 depicts an example of a block diagram illustrating aspects of a de-biasing model for generating de-biased training data, according to certain embodiments of the present disclosure.

FIG. 5 depicts examples of access rates of users based on an access predictive model trained using the original training data, according to certain embodiments of the present disclosure.

FIG. 6 depicts examples of the access rates of users based on an access predictive model trained using the de-biased training data, according to certain embodiments of the present disclosure.

FIG. 7 depicts an example of a computing system for implementing certain embodiments of the present disclosure.

### DETAILED DESCRIPTION

Certain embodiments involve generating de-biased training data for fairness-aware predictive models, and, in some cases, performing various operations that facilitate or otherwise control online access to features and resources of interactive computing environments using the fairness-aware predictive models. For instance, an access-facilitation computing system generates de-biased versions of training data using a de-biasing model that has been developed based on latent features of that training data. The de-biasing model can be trained in a manner that reduces an individual bias of the training data (e.g., ensuring that users with similar attributes being provided similar outcomes in term of granting access to the resources) and also reduces a group bias of the training data (e.g., ensuring that a user's access to resources is determined independently of the group to which the user belongs). The access-facilitation computing system uses the de-biased training data to train the predictive model, where the trained predictive model is used to determine access flags for users. The access flags are associated with the ability of respective users to access the online interactive computing environment. In some embodiments, the access-facilitation computing system causes user devices associated with the users to be provided with access to the online interactive computing environment based on these access flags.

The following non-limiting example is provided to introduce certain embodiments. In this example, an access-facilitation computing system employs a predictive model to determine whether to provide a user with access to online resources via an interactive computing environment. Examples of these resources include cloud computing applications, online storage repositories, interactive content, etc. To train the predictive model, training data can be built based on past determinations on access flags indicating the ability of users to access the online resources. To reduce potential bias within the training data, the access-facilitation computing system employs a de-biasing model to transform the training data to de-biased training data.

More specifically, the access-facilitation computing system generates the latent features of the training data by excluding the bias attributes from the training data and applying an autoencoder to the training data. Based on the latent features, the access-facilitation computing system generates de-biased training data using a generative model. The access-facilitation computing system provides the generated de-biased training data to a statistical discriminative model, which are configured to distinguish between real training data and synthetic de-biased training data, and a group discriminative model. Applying the statistical discriminative model can cause the de-biased training data to be statistically similar to the original training data. Applying the group discriminative model can distinguish between samples with different values of the bias attribute. The access-facilitation computing system performs iterative adjustments of the generative model and the discriminative models to obtain optimized parameters (e.g., neural network parameters) by, for example, minimizing a loss function that enforces the statistical similarity and distinction functions discussed above and reduces data distortion to reduce the individual bias.

The access-facilitation computing system uses the de-biased training data to train the predictive model. The access-facilitation computing system utilizes the trained predictive model to determine whether to provide access to online resources via an online environment to users based on the attributes of these users and to update the access flags of the users accordingly. For example, if the predictive model determines not to provide a particular user the access to the online environment, the access-facilitation computing system can update the access flag of this particular user and cause a user computing device associated with the user be prevented from accessing the online resources, such as by blocking an IP address associated with the user computing device or making the online resources undiscoverable by the user computing device. If the predictive model determines to provide this particular user access to the online environment, the access-facilitation computing system can cause the user computing device associated with the user to access the resources via the online environment such as by positively responding to a pull request from the user computing device or by pushing content or content recommendation to the user computing device. For example, the access-facilitation computing system can control distribution of interactive contents to user computing devices based on the access flags of the users and allow user computing devices to navigate the online environment based on the interactive contents.

As described herein, certain embodiments provide improvements to users' access to the online resources by solving problems that are specific to online platforms. These improvements include reducing both group bias and individual bias in the training data of the predictive model thereby avoiding making biased decisions when providing online resource access to users. Achieving fair decisions for online resource access is uniquely difficult because the decision on granting or denying access must be made within a short period of time, such as a couple of seconds or even shorter. The large number of users and the wide variety of the user attributes considered when making the determinations add additional challenges to this task.

Because this fair access problem is specific to online resources, embodiments described herein utilize automated models that are uniquely suited for online resource access. For instance, a computing system automatically applies various rules (e.g. various relationship between the bias attribute, non-bias attributes and prediction outputs) to the training data to obtain bias corrected training data. The computing system further uses these bias corrected training data to automatically establish new rules (e.g., relationship between user attributes and the predicted outcome on the access permission obtained based on de-biased training data) that are fair and accurately predict the users' activities with respect to the online resources. The computing system applies these new rules automatically to current attributes of the users, sometimes in a real-time manner to determine the access flags for the respective users. Fair and accurate access decisions can enable efficient use of online resources, thereby reducing waste of computing resources, improving quality of service of the online environment. Consequently, certain embodiments more effectively facilitate management of access of online resources, as compared to existing systems.

As used herein, the term “bias” is used to refer to the disproportionate access permission granted in favor of a group of users compared with the rest users in a way considered to be unfair. For example, bias exists when the access permission is determined based on whether a user is a loyalty member of the resource provider which does not reflect the user's activity with respect to the online resource. Bias can include group bias and individual bias.

As used herein, the term “group bias” is used to refer to the bias where proportion of individuals in a selected group with a positive outcome is not identical to the population proportion as a whole. For example, group bias exists if 20% of the non-member users are granted access permission, whereas 60% of the entire user population received access permission. This shows that non-member users are treated unfairly compared with the member users.

As used herein, the term “individual bias” is used to refer to the bias where individuals who have similar attributes do not have similar outcomes. For example, individual bias exists if two users having the same attributes or activities with respect to the online resources receive different decisions in granting the access permission. This shows that users with similar attributes are treated differently.

As used herein, the term “bias attribute” is used to refer to a user attribute whose values represent the different groups to which an individual user can belong to and for which bias reduction is aimed to be achieved for a particular prediction. For example, a bias attribute can include a user's loyalty membership status with a provider of an online resource. Such membership status should not have impact on the decision to grant or deny the user's access to the resource. Bias reduction can be performed on the training data with respect to this bias attribute.

As used herein, the term “training data” is used to refer to original training data that are collected based on past decisions on providing resource access and contain inherent bias due to the use of the bias attribute in the past decisions, whereas the term “de-biased training data” or “bias corrected training data” is used to refer to a transformed version of the training data in which the inherent bias have been reduced or removed.

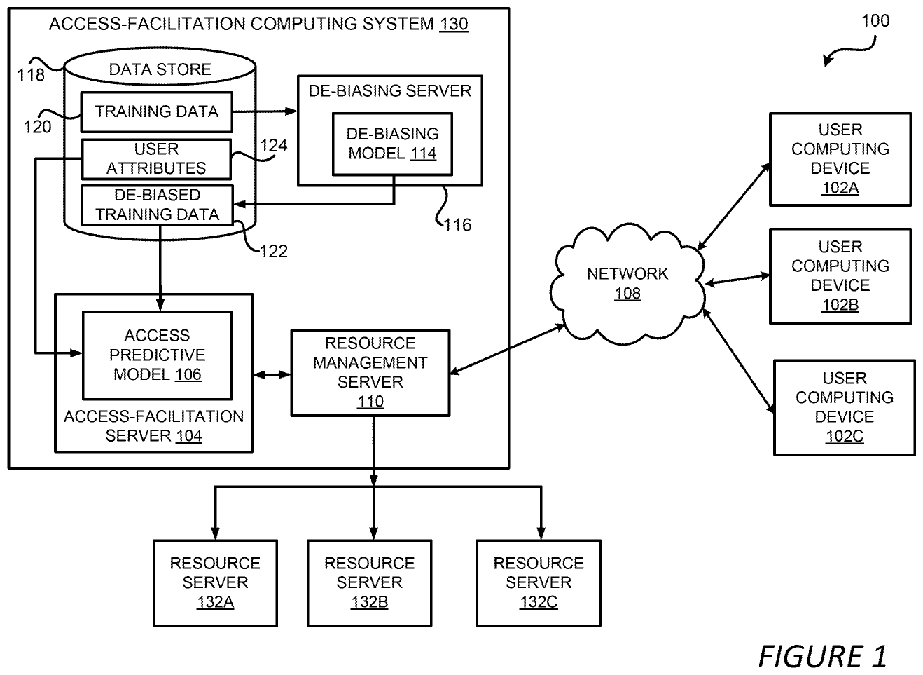

Referring now to the drawings, FIG. 1 is an example of a computing environment 100 in which an access-facilitation computing system employs a de-biasing server to generate de-biased training data for an access predictive model and, in some cases, facilitate online resource access via an online interactive computing environment. In various embodiments, the computing environment 100 includes an access-facilitation computing system 130 and one or more resource servers 132A-132C (which may be referred to herein individually as a resource server 132 or collectively as the resource servers 132). The access-facilitation computing system 130 is configured for facilitating access to various resources hosted on the resource servers 132 by one or more user computing devices 102A-102C (which may be referred to herein individually as a user computing device 102 or collectively as the user computing devices 102).

The resource servers 132 may host online interactive computing environment through which various types of resources can be accessed, such as computing resources, data storage resources, digital content resources and the like. Computing resources may be available as virtual machines configured to execute applications, such as Web servers, application servers, or other types of applications. Data storage resources may include single storage devices, a storage area network, and so on. Digital content resources may include any type of digital contents, such as images, audio, video, files, web pages, emails, text, and the like.

User computing devices 102 can access the online resources through a network 108. For example, a user can employ a user computing device 102 to access, via the online interactive computing environment, storage resources to upload and store personal data, such as files, documents, photos, to access computing resources to execute the software applications, such as hosting a personal webpage, or to access content resources to view, edit, download or otherwise access the content. Resource servers 132, however, have limited capacity to service requests from user computing devices 102 and the quality of service might degrade when the number of users becomes large. In other scenarios, some users who are provided with access to the resources might not access or use the resources efficiently. For example, a user who has requested and been granted access to a storage resource might not visit the storage resource nor store data on the storage resource at all. Providing online resource access to this user would cause waste of resource and also prevent other users from accessing the limited resources. To manage the resource access, the access-facilitation computing system 130 can be utilized to intelligently determine whether a user computing device 102 associated with a particular user can access the resource servers 132.

The access-facilitation computing system 130 can include a resource management server 110, an access-facilitation server 104 and a de-biasing server 116. The access-facilitation server 104 can be configured to determine an access flag for a user indicating whether to provide online resource access to the user based on, for example, attributes or characteristics associated with the user. The resource management server 110 can be configured to allow or deny access to the resource servers 132 based on the access flags generated by the access-facilitation server 104.

For example, to determine whether a user computing device 102 associated with a particular user can access content resources hosted by the resource servers 132, the access-facilitation server 104 can calculate and analyze the user attributes 124 of this particular user. The user attributes 124 can include, but are not limited to, the number of previous access permission granted to this user, the number of visits to the content resources, the access rate by the user after provided with the access, the rate of downloading the content by the user, the total amount of content accessed by the user, etc. If a user visits the resource servers quite often and has a high access rate to the resources and a high downloading rate, the user is more likely to use the resources actively and thus is more likely to be provided with access again. On the other hand, if after being provided with online resource access, a user seldom visit the resource servers, access the resources or download content, the user is less likely to actively use the resources and thus would be denied for future access. The access-facilitation server 104 can employ an access predictive model 106 to determine an access flag indicating whether to provide online resource access to this particular user based on these user attributes 124.

If the access-facilitation server 104 determines not to provide an online resource access to this particular user, the resource management server 110 can prevent the user computing device 102 associated with the user to access the online interactive environment hosted by the resource servers 132 and thereby the resources hosted thereupon. If the access-facilitation server 104 determines to provide online resource access to this particular user, the resource management server 110 can allow the user computing device 102 associated with the user to access the online environment hosted by the resource servers 132 and the resources hosted thereon. The user computing device 102 provided with the access can thus access the computing resources, storage resources, content resources or any other resources hosted by the resource servers 132. In other implementations, the access is determined for each type of resources or each specific resource. In other words, the online resource access allows the user computing device 102 to access a particular resource, such as a particular virtual machine, a particular storage block, or a particular piece of content.

For resources such as content resources, the user computing device 102 can access the resources in a pull mode or a push mode. In the pull mode, a user computing device 102 connects to the resource management server 110 and proactively requests certain content. In the push mode, the resource management server 110 sends certain content or recommendation for content to the user computing device 102 without an explicit request from the user computing device 102. For example, the resource management server 110 can distribute interactive contents to user computing devices based on the access flags of the users and allow the user computing devices to navigate the online environment based on the interactive contents. In either mode, the request for content, the recommendation for the content, the interactive content or the content itself can be sent though the network 108, which may be a local-area network (“LAN”), a wide-area network (“WAN”), the Internet, or any other networking topology known in the art that connects the user computing device 102 to the resource management server 110 and/or the resource servers 132.

In order for the access-facilitation server 104 to determine the access flag for a user using the access predictive model 106, the access predictive model 106 need to be trained using training data 120. The training data 120 can include training inputs and training outputs, and the training involves adjusting parameters of the access predictive model 106 so that the predictions or outputs generated by the access predictive model 106 based on the training inputs are close to the training outputs based on certain quantitative metrics. The training data 120 can include data observed from past determinations on access flags, including the decisions made and the user attributes used in making the decisions. As a result, inherent bias from past determinations are propagated to the access predictive model 106 through the training data 120, leading to biased predictions for future determinations.

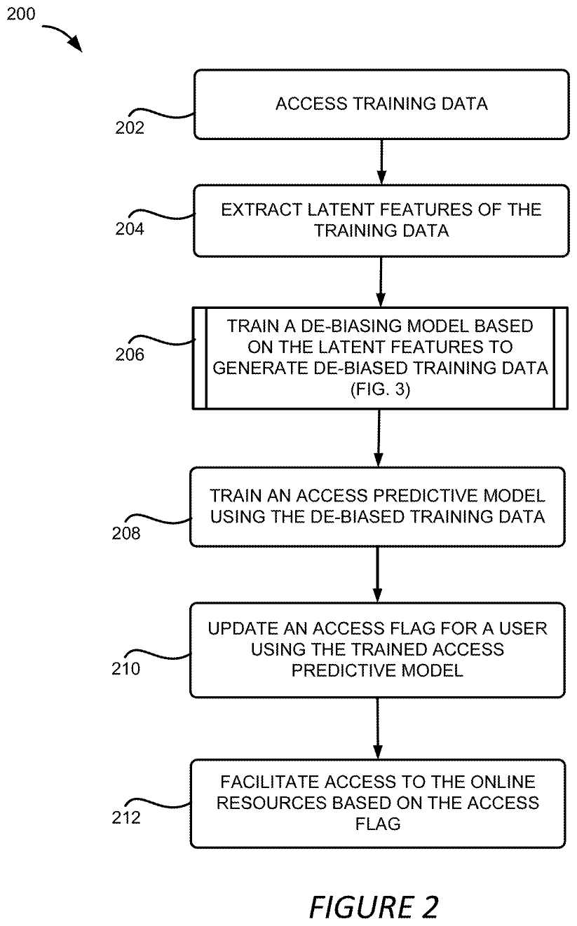

To reduce the impact of the inherent bias, the access-facilitation computing system 130 can employ a de-biasing server 116 to generate bias-corrected training data for the access predictive model 106. The de-biasing server 116 builds and trains a de-biasing model 114 based on the training data 120. The de-biasing server 116 uses the trained de-biasing model 114 to generate de-biased training data 122. Detailed examples of building and training the de-biasing model 114 and generating the de-biased training data 122 are provided below with respect to FIGS. 2-5. The access-facilitation computing system 130 further includes a data store 118 for storing the training data 120, the de-biased training data 122, the user attributes 124 and other data associated with resource access management.

The access-facilitation server 104 can use the de-biased training data 122 to train the access predictive model 106 and use the trained access predictive model 106 to determine the access flags for various users. Based on the access flags, the resource management server 110 grants or denies the access to the resource servers 132 by the user computing devices 102 associated with the users.

FIG. 2 depicts an example of a process 200 for facilitating the online resource access based on an access predictive model 106 trained using de-biased training data 122, according to certain embodiments of the present disclosure. One or more computing devices (e.g., the access-facilitation computing system 130) implement operations depicted in FIG. 2 by executing suitable program code. For illustrative purposes, the process 200 is described with reference to certain examples depicted in the figures. Other implementations, however, are possible.

At block 202, the process 200 involves accessing training data 120 for the access predictive model 106. As discussed above, the training data 120 can include training outputs contain past access flags indicating decisions on granting or denying resource access of users and training inputs that lead to these access flags. The training inputs of the training data 120 may contain various user attributes including at least one bias attribute and non-bias attributes. As discussed above, the impact of the bias attributes might have been propagated to the training data 120 including the non-bias attributes and the training outputs. As such, the de-biasing server 116 performs bias correction on the training data 120 before training the access predictive model 106.

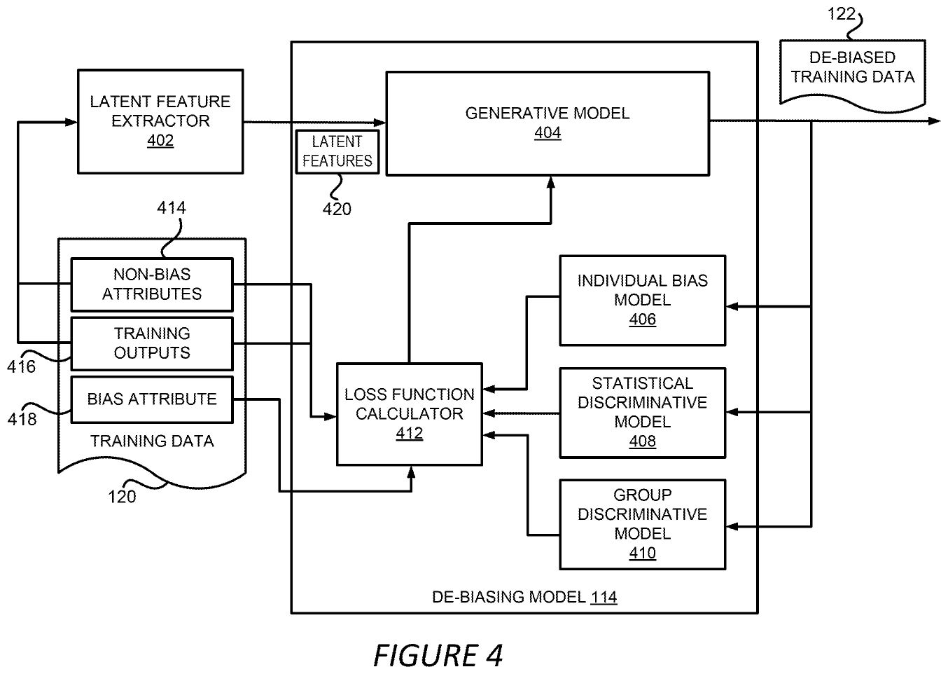

At block 204, the process 200 involves extracting latent features from the training data 120. In one example, the de-biasing server 116 can employ an autoencoder to extract the latent features of the training data 120. An autoencoder is a type of artificial neural network used to learn a low-dimension representation for a set of data, such as the training data 120. In some implementations, the de-biasing server 116 applies the autoencoder on the non-bias attributes of the training inputs and the training outputs to generate the latent features. Additional examples of extracting the latent features are provided below with respect to FIG. 4.

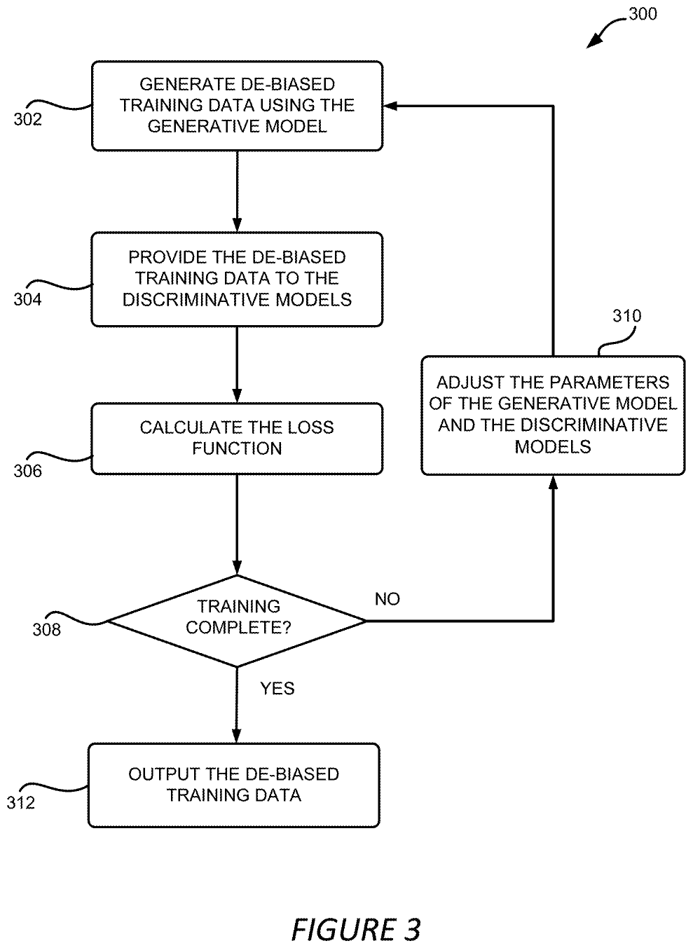

At block 206, the process 200 involves training a de-biasing model 114 to generate de-biased training data 122 using the latent features obtained at block 204 as an input to the de-biasing model 114. The training includes minimizing a loss function of the de-biasing model 114 that includes loss terms associated with at least an individual bias and a group bias of the de-biased training data. As a result, both the individual bias and the group bias are reduced in the generated de-biased training data 122. The generated de-biased training data include transformed training inputs and transformed training outputs. Detailed examples of training the de-biasing model 114 and generating the de-biased training data 122 are presented below with respect to FIGS. 3 and 4.

At block 208, the process 200 involves training the access predictive model 106 using the de-biased training data 122. The access predictive model 106 can be any machine learning model configured to accept user attributes 124 as inputs and output access flags indicating whether to grant resource access to users. For example, the access predictive model 106 can be a logistic regression model, a decision tree model, a random forest model, a naive Bayes model, a neural network or other types of models. The training involves iteratively adjusting the parameters of the access predictive model 106 so that the outputs of the access predictive model 106 given the transformed training inputs of the de-biased training data 122 are close to the transformed training outputs in the de-biased training data 122 based on certain quantitative metrics.

At block 210, the process 200 involves generating or updating the access flag for a user using the trained access predictive model 106. The access-facilitation server 104 can use the user attributes 124 for the current user as the inputs to the access predictive model 106, and determine whether to grant resource access to the current user based on the output of the access predictive model 106. At block 212, the process 200 involves facilitating access to the online resources based on the access flags determined at block 210. If the access predictive model 106 determines to grant access for the current user, the resource management server 110 would allow the user computing device 102 associated with the current user to access the resource servers 132 or to push content resources to the user computing device 102; otherwise, the resource management server 110 would prevent the user computing device 102 from receiving, downloading, reviewing or otherwise accessing the online resources.

FIG. 3 depicts an example of process 300 for training a de-biasing model 114 for generating de-biased training data 122, according to certain embodiments of the present disclosure. The process 300 can be used to implement block 206 of the process 200. One or more computing devices (e.g., the access-facilitation computing system 130 or the de-biasing server 116) implement operations depicted in FIG. 3 by executing suitable program code. For illustrative purposes, the process 300 is described with reference to certain examples depicted in FIG. 4. Other implementations, however, are possible.

At block 302, the process 300 involves generating de-biased training data 122 based on current parameters of the de-biasing model 114. FIG. 4 shows an example of a de-biasing model 114 according to certain embodiments of the present disclosure. In this example, the de-biasing model 114 is a generative adversarial network (“GAN”) model that includes a generative model 404 and two discriminative models: a statistical discriminative model 408 and a group discriminative model 410. In one implementation, the generative model 404 is configured to include a multi-layer neural network, such as a three-layer neural network, and use the latent features extracted from the training data 120 as inputs to generate de-biased training data 122.

As shown in FIG. 4, the de-biasing server 116 can employ a latent feature extractor 402 to extract the latent features 420 from training data 120. As discussed above, the training data 120 include training outputs 416, denoted as Y, and training inputs containing one or more bias attributes 418, denoted as S, and multiple non-bias attributes 414, denoted as X. For simplicity, the training data 120 presented herein contain one bias attribute 418. It should be understood that training data 120 containing multiple bias attributes 418 can be de-biased in a similar manner as described herein.

As briefly mentioned above, the latent feature extractor 402 can include an autoencoder. In some implementations, the autoencoder is configured to extract latent features 420, denoted as z, from the non-bias attributes X, and the training outputs Y, i.e. z=Enc(X,Y). The loss function L_{AE} for the autoencoder can be defined as Mean Square Error (“MSE”) between the original data (X, Y), e.g. the concatenation of X and Y, and reconstructed data based on the latent features z, i.e. Dec(z). Thus, training the autoencoder involves solving the following optimization problem:

$${min}_{z} {L}_{A E} = {min}_{z} {‖ Dec ( z ) - ( X , Y ) ‖}_{2}^{2} . \qquad ( 1 )$$

The generative model 404 can use the extracted latent features z as an input and generate de-biased training data 122, i.e.

G(z)=(X′,Y′), (2)

where G is the generative model 404, (X′,Y′) is the de-biased training data 122, X′ is the transformed training inputs and Y′ is the transformed training outputs. Note that the transformed training inputs X′ correspond to the non-bias attributes X and thus does not include the bias attribute S.

Referring back to FIG. 3, at block 304, the process 300 involves providing the de-biased training data 122 to the discriminative models of the de-biasing model 114, i.e. the statistical discriminative model 408 and the group discriminative model 410 as shown in FIG. 4. The statistical discriminative model 408 aims to have the statistical distribution of the de-biased training data 122 close to that of the training data 120. That is, the joint distribution of transformed data p{X′,Y′} is statistically close to the original distribution p{X, Y}. By implementing the statistical discriminative model 408 in this way, the de-biasing model 114 essentially incorporates the above constraint of statistical closeness in the generation of the de-biased training data 122. Denoting the statistical discriminative model 408 as D1 and assuming D1 is a binary classifier that predicts whether an input is real training data 120 or generated data obtained from G(z), the objective function for D1, maximized over D1 and minimized over G(.), can be defined as:

$${min}_{G} {max}_{D 1} {E}_{\{ X , Y \}} [ log D 1 ( X , Y ) ] + {E}_{G ( z )} [ log ( 1 - D 1 ( G ( z ) ) ) ] \qquad ( 3 )$$

The group discriminative model 410, on the other hand, aims to achieve group fairness by reducing the group bias of the de-biased training data 122. One way to achieve group fairness is to obfuscate the bias attribute S from the de-biased training data 122 (X′,Y′) thereby removing the dependency or association between S and (X′,Y′). The group discriminative model 410, denoted as D2, can thus be configured to distinguish between samples from groups where S has different values, i.e. P [G(z)|S=1] and P [G(z)|S=0] for a binary S, and the generator G(.) can be configured to generate samples from each group with probability as similar as possible. The objective function for D2, maximized over D2 and minimized over G(.) can be defined as:

$${min}_{G} {max}_{D 2} {E}_{\{ G \vert S = 1 \}} [ log D 2 ( G ( z ) ) ] + {E}_{\{ G \vert S = 0 \}} [ log ( 1 - D 2 ( G ( z ) ) ) ] \qquad ( 4 )$$

In some implementations, both discriminative models D1 and D2 can employ a fully-connected neural network with three hidden layers with Leaky-ReLU activation function after each layer and employ Sigmoid activation function in the output layer. The Sigmoid activation function for the statistical discriminative model D1 can be configured for predicting whether the input data to the discriminative model is from real training data 120 or samples generated by the generative model 404. For the group bias discriminative model D2, the Sigmoid output layer can be configured to predict the probability that an input is an observation from one of the groups of the bias attribute S. During training, the models can adopt the Adam optimizer. For the GAN learning process, the generative model G can be initialized with the pre-trained weights from the autoencoder. Similarly, the statistical discriminative model D1 and the group bias discriminative model D2 can also be initialized with weights of pre-trained classifiers.

In further implementations, the de-biasing model 114 can also include an individual bias model 406 that is configured to reduce the individual bias in the de-biased training data 122. In one example, the individual bias model 406 includes a data distortion measurement, such as an MSE, to control the distortion between the training data 120 and the de-biased training data 122. The individual bias model 406 can be configured to reduce or remove pointwise any large deviations between the training data 120 and the de-biased training data 122. This pointwise constraint helps to maintain individual fairness, because for every individual user, the de-biased training data 122 are maintained to be as close as possible to the training data 120. As a result, different users with different user attributes are treated differently whereas users with similar user attributes are treated similarly. Denoting the distortion metric Δ, the distortion constraint can be defined as

Δ((X,Y),(X′,Y′))=∥G(z)−(X,Y)∥₂² (5)

Referring back to FIG. 3, at block 306, the process 300 involves calculating the loss function for the de-biasing model 114. As shown in FIG. 4, the de-biasing server 116 can employ a loss function calculator 412 to calculate the loss function. In one example, the loss function calculator 412 can combine the loss functions of the various models discussed above. For example, the loss function calculator 412 can define the overall loss function for the de-biasing model 114 as

$$\begin{matrix} L ( G , D 1 , D 2 ) = {L}_{1} ( G , D 1 ) + {λ}_{1} {L}_{2} ( G , D 2 ) + {λ}_{2} {L}_{M S E} , \\ where & ( 6 ) \\ {L}_{1} ( G , D 1 ) = {min}_{G} {max}_{D 1} {E}_{\{ X , Y \}} [ log D 1 ( X , Y ) ] + {E}_{G ( z )} [ log ( 1 - D 1 ( G ( z ) ) ) ] , \\ {L}_{2} ( G , D 2 ) = {min}_{G} {max}_{D 2} {E}_{\{ G \vert S = 1 \}} [ log D 2 ( G ( z ) ) ] + {E}_{\{ G \vert S = 0 \}} [ log ( 1 - D 2 ( G ( z ) ) ) ] , \\ {L}_{M S E} = Δ ( ( X , Y ) , ( {X}^{′} , {Y}^{′} ) ) = {‖ G ( z ) - ( X , Y ) ‖}_{2}^{2} , & \end{matrix}$$

λ₁ and λ₂ are parameters for adjusting the relative importance of the different loss terms in the loss function.

With the above definition of the loss function, training the de-biasing model 114 involves solving the following optimization problem:

$${min}_{G} {max}_{D 1 , D 2} L ( G , D 1 , D 2 ) . \qquad ( 7 )$$

The training process essentially performs a minimax optimization between the generative model 404 and the discriminative models D1 and D2. As discussed above, D1 aims to accurately distinguish between real training data 120 and generated de-biased training data 122, and D2 seeks to distinguish between samples with different values of the bias attribute 418. The de-biasing model 114 also aims to reduce the MSE between the training data 120 and the generated de-biased training data 122 to control data distortion. It should be understood that the overall loss function L(G, D1, D2) of the de-biasing model 114 can be defined in various other ways to achieve different goals. For example, the overall loss function can include only L₂(G, D2) and L_{MSE} to emphasize on reducing the individual and group bias, or include L₁(G, D1) and L_{MSE} if group bias is of less concern. The overall loss function can also include loss terms other than the loss terms described above.

At block 308, the process 300 involves determining whether the training of the de-biasing model 114 is complete. In some implementations, the training process involves performing iterative adjustments of parameters of the de-biasing model 114 to minimize the overall loss function. The iterative adjustments can include adjusting the parameters of the de-biasing model 114, including the generative model 404, the statistical discriminative model 408, and the group discriminative model 410, so that a value of the overall loss function in a current iteration is smaller than the value of the overall loss function in another iteration.

In those implementations, the de-biasing server 116 can determine that the training is complete if the training process has converged, i.e. the decrease in the overall loss function between the current iteration and the previous iteration is below a threshold value. The de-biasing server 116 can also determine that the training is complete if a maximum number of iterations has been reached and the value of the loss function is below a certain threshold value. The de-biasing server 116 can use various other criteria to determine that the training of the de-biasing model 114 is complete.

If the de-biasing server 116 determines that the training process is not complete, the process 300 involves, at block 310, adjusting the parameters of the de-biasing model 114, such as the weights of the generative model 404, the statistical discriminative model 408, and the group discriminative model 410. With the adjusted models, the process 300 enters a new iteration where the de-biasing server 116 generates another set of de-biased training data 122 using the adjusted de-biasing model 114 at block 302 and repeats the operations described above. If, at block 308, the de-biasing server 116 determines that the training process is complete, the process 300 involves outputting the de-biased training data 122 generated in the current iteration as the final de-biased training data 122. In other words, de-biased training data 122 generated by the generative model 404 with the final model parameters are the final de-biased training data 122 to be used to train the access predictive model 106.

It should be understood that while the above description focuses on using the latent features 420 of the training data 120 as inputs to the generative model 404, other types of inputs, such as random noise, can also be used to generate the de-biased training data 122. Compared with other types of inputs, the latent features 420 can increase the converging speed of the training process of the de-biasing model 114, and thus reduces the computational resource consumption in the model training stage.

Example of Generating De-Biased Training Data for Facilitating Content Resource Access

In this example, the training data for facilitating access to a content resource, such as a web page or an email, are analyzed and transformed to reduce both the individual bias and the group bias. The training data 120 used for de-biasing contain access flags for more than half million individuals over a period of 13 months. The first 12 months of data are used to train the de-biasing model 114 to generate de-biased training data 122. The data from month 13 are used for prediction using an access predictive model 106 built based on a logistic regression model and trained using the de-biased training data 122. In this data set, the output Y, is whether the resource management server 110 will continue to allow a user to access the content resource, such as through distributing interactive contents to user computing devices, in the next month. The bias attribute S is whether an individual is a loyalty member of the resource provider. The non-bias attributes X include, but are not limited to, the number times that the resource management server 110 has provided resource access to the user, the number of visits to the content resources, the access rate by the user after providing the resource access, the rate of downloading the content by the user, total amount of content accessed by the user, and so on.

In order to evaluate the performance of the de-biasing model 114 presented herein, a baseline model is used to transform the training data 120 to generate baseline data. The baseline data are the same as the original training data 120, except for the bias attribute S. The bias attribute S for each user in the baseline data is based on a random sample drawn from a Bernoulli distribution, i.e.

$$\begin{matrix}S \text{∼} Bernoulli ( 0 , p ) , & ( 7 ) \\ where p = \frac{{n}_{S = 1}}{N} , & \end{matrix}$$

n_{S=1} is the number of samples in the training data 120 having S equal to 1, and N is the total number of samples in the training data 120. In other words, the selected values for S follows the Bernoulli distribution with a success probability equal to the probability of getting S=1 in the original training data 120. This is equivalent to randomly selecting users from the user pool to be a loyalty member, independent of Y. As such, the baseline data are free of group bias.

Table 1 shows the bias scores of the original training data 120, the baseline data generated by the baseline model and the de-biased training data 122 generated by the de-biasing model 114. Here, the group bias score is defined as

ϕ_{G}=|P(Y=y|S=0)−P(Y=y|S=1)|, (8)

where P(α) represents the probability of the event α. As discussed above, the group bias measures the discrimination with respect to the bias attribute S and output Y, i.e. the decision of providing or denying resource access. Complete group fairness is achieved when P (Y=y) is equal for all values of S, that is, P (Y=y)=P (Y=y|S=s). As such, a group bias score ϕ_{G} close to 0 means that the training data is less biased in terms of group bias.

Individual bias measures the consistency of treating similar individuals with similar attributes regardless of the value of the bias attribute. Individual bias score can be defined as:

$${φ}_{I} = {\sum }_{k = 1}^{K} {w}_{k} \frac{min ( {Σ}_{i} {Y}_{ik} , {Σ}_{i} ( 1 - {Y}_{i k} ) )}{max ( {Σ}_{i} {Y}_{ik} , {Σ}_{i} ( 1 - {Y}_{i k} ) )} , \qquad ( 8 )$$

where all the users in the data set are assigned to one of K clusters, Yᵢₖ is the predicted output for the ith user (having value 0 or 1) in the kth cluster. wₖ=nₖ/N is the weight for the kth cluster, where nₖ is the number of users in the kth cluster and N is the total number of users in the data set. In an ideal situation, users in each cluster is as similar as possible based on the users' attributes and in the absence of individual bias, users in each cluster will have the same value of Yᵢₖ, leading to the value of the numerator in ϕ₁ equal to 0. As such, an individual bias score close to 0 indicates that the training data is less biased in terms of individual bias.

According to Table 1, the de-biased training data 122 generated by the de-biasing model 114 presented herein reduces both group bias and individual bias compared with the training data 120. Because of the manner in which the baseline data is generated, the baseline data can achieve a fairly low group bias score, but cannot reduce the individual bias of the training data 120.

TABLE 1
Bias scores for different training data

| | Original Training | Baseline | De-biased Training |
|---|---|---|---|
| Bias | Data | Data | Data |
| Group | 0.319 | 0.001 | 0.251 |
| Individual | 0.248 | 0.248 | 0.022 |

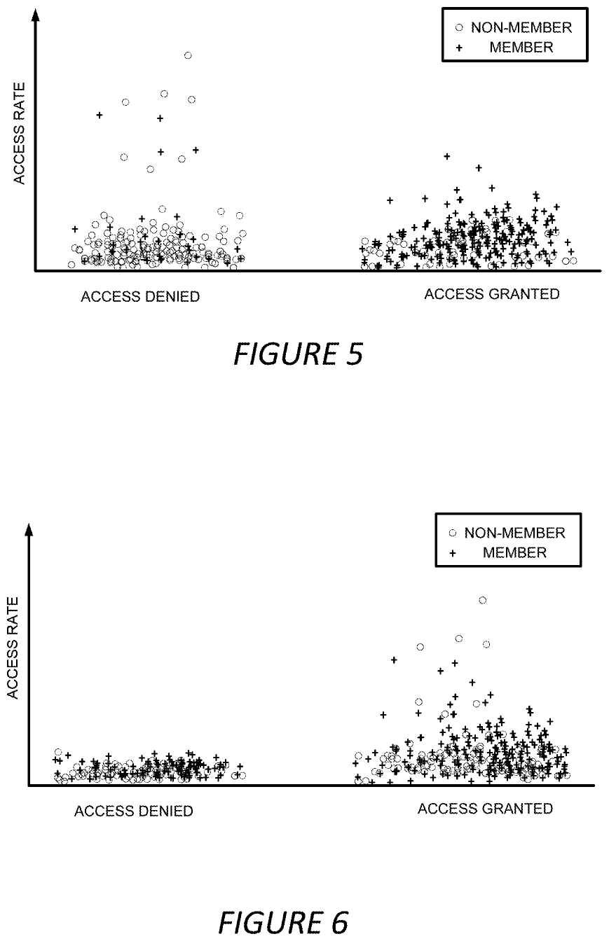

FIGS. 5 and 6 illustrate access rates of the users predicted to be granted or denied access of the content. The access-facilitation server 104 employs a logistic regression model as the access predictive model 106. FIG. 5 illustrates the access rates of the users based on an access predictive model 106 trained using the training data 120, and FIG. 6 illustrates the access rates of the users based on an access predictive model 106 trained using the de-biased training data 122. According to FIG. 5, some of the individuals who are predicted to be denied access to the content based on the original training data 120, actually have high access rates and should have been granted access permission. FIG. 6 shows that those users are provided with access if the access predictive model 106 is trained using the de-biased training data 122. As such, the bias correction mechanism proposed herein can facilitate to provide resource access to individuals who had more interactions with the content resource in the past whereas denying resource access to individuals who were less active in the past.

Example of a Computing System for Implementing Certain Embodiments

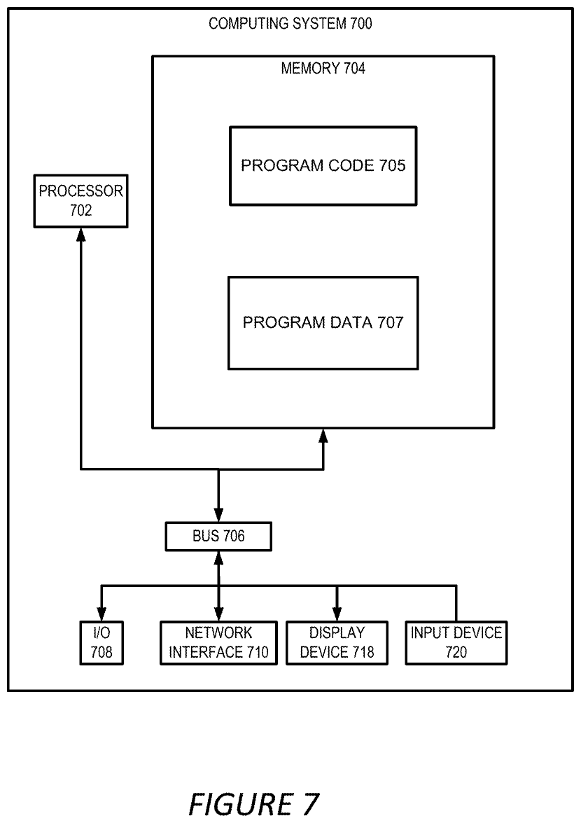

Any suitable computing system or group of computing systems can be used for performing the operations described herein. For example, FIG. 7 depicts an example of the computing system 700. The implementation of computing system 700 could be used to implement a de-biasing server 116, an access-facilitation server 104, or a resource management server 110. In other embodiments, a single computing system 700 having devices similar to those depicted in FIG. 7 (e.g., a processor, a memory, etc.) combines the one or more operations and data stores depicted as separate systems in FIG. 1.

The depicted example of a computing system 700 includes a processor 702 communicatively coupled to one or more memory devices 704. The processor 702 executes computer-executable program code stored in a memory device 704, accesses information stored in the memory device 704, or both. Examples of the processor 702 include a microprocessor, an application-specific integrated circuit (“ASIC”), a field-programmable gate array (“FPGA”), or any other suitable processing device. The processor 702 can include any number of processing devices, including a single processing device.

A memory device 704 includes any suitable non-transitory computer-readable medium for storing program code 705, program data 707, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 700 executes program code 705 that configures the processor 702 to perform one or more of the operations described herein. Examples of the program code 705 include, in various embodiments, the application executed by the de-biasing server 116 to train the de-biasing model 114, the application executed by the access-facilitation server 104 to train the access predictive model 106 or other suitable applications that perform one or more operations described herein. The program code may be resident in the memory device 704 or any suitable computer-readable medium and may be executed by the processor 702 or any other suitable processor.

In some embodiments, one or more memory devices 704 stores program data 707 that includes one or more datasets and models described herein. Examples of these datasets include interaction data, performance data, etc. In some embodiments, one or more of data sets, models, and functions are stored in the same memory device (e.g., one of the memory devices 704). In additional or alternative embodiments, one or more of the programs, data sets, models, and functions described herein are stored in different memory devices 704 accessible via a data network. One or more buses 706 are also included in the computing system 700. The buses 706 communicatively couples one or more components of a respective one of the computing system 700.

In some embodiments, the computing system 700 also includes a network interface device 710. The network interface device 710 includes any device or group of devices suitable for establishing a wired or wireless data connection to one or more data networks. Non-limiting examples of the network interface device 710 include an Ethernet network adapter, a modem, and/or the like. The computing system 700 is able to communicate with one or more other computing devices (e.g., a user computing device 102) via a data network using the network interface device 710.

The computing system 700 may also include a number of external or internal devices, an input device 720, a presentation device 718, or other input or output devices. For example, the computing system 700 is shown with one or more input/output (“I/O”) interfaces 708. An I/O interface 708 can receive input from input devices or provide output to output devices. An input device 720 can include any device or group of devices suitable for receiving visual, auditory, or other suitable input that controls or affects the operations of the processor 702. Non-limiting examples of the input device 720 include a touchscreen, a mouse, a keyboard, a microphone, a separate mobile computing device, etc. A presentation device 718 can include any device or group of devices suitable for providing visual, auditory, or other suitable sensory output. Non-limiting examples of the presentation device 718 include a touchscreen, a monitor, a speaker, a separate mobile computing device, etc.

Although FIG. 7 depicts the input device 720 and the presentation device 718 as being local to the computing device that executes the de-biasing server 116, other implementations are possible. For instance, in some embodiments, one or more of the input device 720 and the presentation device 718 can include a remote client-computing device that communicates with the computing system 700 via the network interface device 710 using one or more data networks described herein.

General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. A method in which one or more processing devices perform operations comprising:
extracting latent features from training data of a first machine learning model;
training, based on the latent features, a second machine learning model to generate de-biased training data by applying a loss function that comprises a first loss term associated with an individual bias of the de-biased training data and a second loss term associated with a group bias of the de-biased training data;
training the first machine learning model using the de-biased training data;
updating an access flag for a user by applying the first machine learning model, as trained with the de-biased training data, to attributes associated with the user, wherein the access flag is associated with an ability of the user to access an online environment; and
causing a user device associated with the user to be provided with access to the online environment based on the updated access flag for the user.

2. The method of claim 1, wherein the training data comprising training inputs and training outputs, each of the training inputs containing a bias attribute and non-bias attributes, and wherein the latent features are extracted using the non-bias attributes of the training inputs and the training outputs.

3. The method of claim 2, wherein the second machine learning model is a generative adversarial network (GAN) comprising a generative model for generating the de-biased training data and a first discriminative model for generating the second loss term associated with the group bias of the de-biased training data.

4. The method of claim 3, wherein the first discriminative model is configured to predict a value of the bias attribute for each entry of the de-biased training data, and wherein the second loss term is calculated based on predicted values of the bias attribute.

5. The method of claim 3, wherein the first loss term associated with the individual bias of the de-biased training data is calculated based on a difference between the de-biased training data and the non-bias attributes of the training inputs and the training outputs.

6. The method of claim 3, wherein the loss function of the second machine learning model further comprises a third loss term associated with a statistical closeness of the de-biased training data to the training data, and wherein the second machine learning model further comprises a second discriminative model for generating the third loss term of the loss function.

7. The method of claim 6, wherein the second discriminative model is configured to predict whether the de-biased training data are generated by the generative model or belong to the training data, and wherein the third loss term is calculated based on the prediction.

8. The method of claim 7, wherein training the second machine learning model comprises iteratively performing the operations comprising:
generating the de-biased training data using the generative model;
providing the de-biased training data and the training data to the first and the second discriminative models; and
updating one or more parameters of the generative model, the first discriminative model or the second discriminative model such that a value of the loss function in a current iteration is smaller than the value of the loss function in a previous iteration.

9. A system comprising:
a processing device; and
a non-transitory computer-readable medium communicatively coupled to the processing device, wherein the processing device is configured to execute program code stored in the non-transitory computer-readable medium and thereby perform operations comprising:
accessing training data of a first machine learning model, the training data comprising training inputs, each containing a bias attribute and non-bias attributes, and training outputs;
training a second machine learning model configured for generating de-biased training data by applying a loss function that comprises a first loss term associated with an individual bias of the de-biased training data and a second loss term associated with a group bias of the de-biased training data, wherein the de-biased training data comprise transformed training inputs containing the non-bias attributes and transformed training outputs;
training the first machine learning model using the de-biased training data; and
updating an access flag for a user by applying the first machine learning model, as trained with the de-biased training data, to non-bias attributes associated with the user, wherein the access flag is associated with an ability of the user to access an online environment and is usable for providing a user device associated with the user with access to the online environment.

10. The system of claim 9, wherein the second machine learning model is a generative adversarial network (GAN) comprising a generative model for generating the de-biased training data.

11. The system of claim 10, wherein the generative model generates the de-biased training data using random inputs.

12. The system of claim 10, wherein the operations further comprise calculating latent features of the training data using the non-bias attributes of the training inputs and the training outputs, and wherein the generative model generates the de-biased training data based on the latent features.

13. The system of claim 10, wherein the GAN further comprises a discriminative model for generating the second loss term associated with the group bias of the de-biased training data, the discriminative model configured to predict a value of the bias attribute for each entry of the de-biased training data, and wherein the second loss term is calculated based on predicted values of the bias attribute.

14. The system of claim 9, wherein the first loss term associated with the individual bias of the de-biased training data is calculated based on a difference between the de-biased training data and the non-bias attributes of the training inputs and the training outputs.

15. A non-transitory computer-readable medium having program code that is stored thereon, the program code executable by one or more processing devices for performing operations comprising:
accessing training data of a first machine learning model, the training data comprising training inputs, each containing a bias attribute and non-bias attributes, and training outputs;
training a second machine learning model configured for generating de-biased training data by applying a loss function that comprises a first loss term associated with an individual bias of the de-biased training data and a second loss term associated with a group bias of the de-biased training data, wherein the de-biased training data comprise transformed training inputs containing the non-bias attributes and transformed training outputs;
training the first machine learning model using the de-biased training data; and
updating an access flag for a user by applying the first machine learning model, as trained with the de-biased training data, to non-bias attributes associated with the user, wherein the access flag is associated with an ability of the user to access an online environment and is usable for providing a user device associated with the user with access to the online environment.

16. The non-transitory computer-readable medium of claim 15, wherein the second machine learning model is a generative adversarial network (GAN) comprising a generative model for generating the de-biased training data and a first discriminative model for generating the second loss term associated with the group bias of the de-biased training data.

17. The non-transitory computer-readable medium of claim 16, wherein the first discriminative model is configured to predict a value of the bias attribute for each entry of the de-biased training data, and wherein the second loss term is calculated based on predicted values of the bias attribute.

18. The non-transitory computer-readable medium of claim 16, wherein the first loss term associated with the individual bias of the de-biased training data is calculated based on a difference between the de-biased training data and the non-bias attributes of the training inputs and the training outputs.

19. The non-transitory computer-readable medium of claim 16, wherein the loss function of the second machine learning model further comprises a third loss term associated with a statistical closeness of the de-biased training data to the training data, and wherein the second machine learning model further comprises a second discriminative model for generating the third loss term of the loss function.

20. The non-transitory computer-readable medium of claim 19, wherein the second discriminative model is configured to predict whether the de-biased training data are generated by the generative model or belong to the training data, and wherein the third loss term is calculated based on the prediction.
